(19) United States
(12) Patent Application Publication
(10) Pub. No.: US 2020/0080969 A1
(43) Pub. Date: Mar. 12, 2020

(54) METHOD FOR ACQUIRING SIGNALS BY ULTRASOUND PROBING, CORRESPONDING COMPUTER PROGRAM AND ULTRASOUND PROBING DEVICE

(71) Applicants: Commissariat a I'energie atomique et aux energies alternatives, Paris (FR); Centre National de la Recherche Scientifique, Paris Cedex 16 (FR)

(72) Inventors: Eduardo-Rigoberto LOPEZ VILLAVERDE, Massy (FR); Sebastian ROBERT, Le Kremlin-Bicetre (FR); Claire PRADA JULIA, Paris (FR)

(73) Assignees: Commissariat a I'energie atomique et aux energies alternatives, Paris (FR); Centre National de la Recherche Scientifique, Paris Cedex 16 (FR)

(21) Appl. No.: 16/470,027

(22) PCT Filed: Dec. 5, 2017
(86) PCT No.: PCT/FR2017/053390

§ 371 Date: Jun. 14, 2019

(30) Foreign Application Priority Data
Dec. 15, 2016 (FR) 1662523

(51) Int. Cl. G01N 29/06; G01N 29/26; G01N 29/44

(52) U.S. Cl. CPC G01N 29/069; G01N 2291/0289; G01N 29/4463; G01N 29/262

(57) ABSTRACT

A method for acquiring signals via ultrasound probing including: controlling L emission transducers and N reception transducers in order to simultaneously receive, for each of M successive emissions, N measurement signals; obtaining a matrix of ultrasound time signals having a size of N×M. An initial matrix ([MC′]), having a size of L×M', for encoding the successive emissions is previously defined for a number M′ of successive initial emissions strictly greater than M. A calculation of acoustic field is carried out for each of the M′ initial emissions. A reduced encoding matrix ([MC]), having a size of L×M, is obtained by removal of M′−M columns of the initial encoding matrix ([MC′]) on the basis of a selection criterion applied to the M′ calculations of acoustic fields. Finally, the control of the L emission transducers for the M successive emissions is encoded using the reduced encoding matrix ([MC]).

The present invention relates to a method for acquiring signals by ultrasound probing, for example in order to carry out imaging or adaptive and selective focusing. It also relates to a corresponding computer program and ultrasound probing device.

The invention applies in particular to the field of non-destructive testing via ultrasounds, wherein the acquisition of ultrasound signals allows to detect and/or to display defects in structures, but it can also apply to any type of ultrasound echographic detection or imaging, in particular to the medical field for the inspection of zones of interest in the human or animal body.

It relates more particularly to a method for acquiring ultrasound signals operating in the following manner:
controlling L emission transducers for M successive emissions of ultrasound waves towards a zone of interest,
controlling N reception transducers in such a way as to receive simultaneously and over a predetermined time, for each of the M successive emissions, N measurement signals, measuring in particular echoes caused by reflections of the emission in question in the zone of interest,
obtaining a matrix [MR(t)] of ultrasound time signals having a size of N×M, each coefficient MR_{i,j}(t) of this matrix representing the measurement signal received by the i-th reception transducer caused by the j-th emission.

Such an acquisition is generally carried out using a probing device with a multielement sensor, wherein each transducer is both an emitter and receiver, and switching between these two modes can be controlled electronically. The sensor can be placed in contact with the object to be probed or at a distance, but in the latter case it must be submerged in order to ensure the transmission of the ultrasound waves into the object to be probed. This sensor can be linear (1D) or matrix (2D), with rigid or flexible elements.

The matrix [MR(t)] of time signals obtained by this type of acquisition can then be subjected to processing, in particular for providing an image of the zone of interest inspected or for the extraction of parameters signifying structural defects in the zone of interest inspected. Given the current calculation capacities of processors, this processing can be on board in the control instruments for real-time processing.

In practice, the control of the L emission transducers for the M successive emissions of ultrasound waves towards the zone of interest can be encoded using an encoding matrix [MC], each coefficient MC_{i,j} of this matrix representing a multiplication factor applied to a common excitation time signal e(t) for its emission by the i-th emission transducer at the time of the j-th emission. Delay laws can further be applied to the successive emissions.

When [MC] is the identity matrix and no delay law is applied, the ultrasound acquisition previously defined is qualified as FMC acquisition (from “Full Matrix Capture”). It consists of emitting an ultrasound wave by exciting the first emission transducer and receiving the echoes of this emission with all of the N reception transducers, then electronically switching to all of the emission transducers in order to successively excite them. When it is the same transducers that carry out the functions of emission and of reception, a matrix [MR(t)], noted as [K(t)], of ultrasound time signals having a size of N×N is obtained.

In imaging, the ultrasound time signals forming the coefficients of the matrix [K(t)] are used to carry out synthetic focusing of the “total focusing method” type which allows to obtain an image with optimal resolution throughout the zone of interest. However, in the presence of strong electronic or structural noise, the reconstruction via the total focusing method can provide images of lesser quality compared to the conventional echographic methods. Indeed, in the latter, all the transducers emit simultaneously via the application of a predetermined delay law in such a way as to focus on a given point. However, according to the FMC acquisition method generally implemented to then carry out the reconstruction via synthetic focusing, each emission is carried out by a single transducer which limits the energy transmitted and the depth of penetration of the waves into the part inspected. Finally, this manifests itself as a degradation of the Signal-to-Noise Ratio (SNR) since the amplitudes of the echo signals can be comparable to the level of electronic or structural noise. This degradation of the SNR is even greater when the attenuation of the ultrasound waves is high (viscoelastic attenuation, or attenuation by diffusion due to heterogeneities in the medium), making the detection and the characterisation of possible defects difficult.

A partial solution to this problem of degradation of the SNR is provided in the article by Karaman et al, entitled “Synthetic aperture imaging for small scale systems”, published in IEEE Transactions on Ultrasonics, Ferroelectrics, and Frequency Control, vol. 42, No. 3 (May 1995), pages 429-442.

It involves using, for each emission, not a transducer but a plurality of adjacent transducers. A delay law is applied to the emission transducers used in order for them to transmit, into the medium, a spherical ultrasound wave, close to that which would be emitted by a virtual source located at a certain distance from the sensor. The ultrasound wave thus emitted by the virtual source is more intense since its energy is proportional to the square root of the number of emission transducers forming this source. The SNR is improved as much, when supposing that the noise generated is mainly uncorrelated electronic noise. The corresponding encoding matrix [MC] comprises a plurality of non-zero coefficients in each of its columns, precisely defining the number of adjacent transducers used simultaneously at each emission and the delay laws optionally applied.

However, in the case of inspected parts having very significant noise, the improvement in the quality of the images finally obtained by the synthetic total focusing is more limited, the increase in the SNR is lesser and the impact on the detection is not as positive as could be expected. This solution partly compensates for the aforementioned problem but does not eliminate it. Indeed, the increase in the SNR is proportional to the square root of the number of transducers forming each virtual source, and this number is much smaller than the total number of transducers N of the sensor. Moreover, emitting via virtual sources does not allow the problem that can be posed by the reconstruction artefacts substantially caused by the parasite echoes such as the geometry echoes or the complex echoes that include multiple reflections on the borders of the object and mode conversions to be eliminated.

Another solution to this problem of degradation of the SNR is provided in the article by Lopez Villaverde et al, entitled “Ultrasonic imaging in highly attenuating materials with Whalsh-Hadamard codes and the decomposition of the time reversal operator”, published for the conference IEEE International Ultrasonics Symposium which took place in Tours (FR) from 18 to 21 Sep. 2016. It consists of encoding the emissions using a Hadamard matrix [MC] noted as H₋). It has been demonstrated that with this type of emission encoding, a matrix [MR(t)] of time signals equivalent to [K(t)] after decoding is obtained with an improved SNR. But in order to obtain an SNR significantly better than in the previous solutions, it generally imposes a large number of successive emissions, for example 2N-1 if the transducers are used in emission using the encoding matrices H_{N}⁻ and H_{N}⁻.

It may thus be desired to provide a method for acquiring ultrasound signals that allows to overcome at least a portion of the aforementioned problems and constraints.

A method for acquiring signals via ultrasound probing, comprising the following steps, is therefore proposed:
controlling L emission transducers for M successive emissions of ultrasound waves towards a zone of interest,
controlling N reception transducers in such a way as to receive simultaneously and over a predetermined time, for each of the M successive emissions, N measurement signals, measuring in particular echoes caused by reflections of the emission in question in the zone of interest,
obtaining a matrix [MR(t)] of ultrasound time signals having a size of N×M, each coefficient MR_{i,j}(t) of this matrix representing the measurement signal received by the i-th reception transducer caused by the j-th emission. according to which:
an initial matrix [MC′], having a size of L×M', for encoding the successive emissions is previously defined for a number M′ of successive initial emissions strictly greater than M, each coefficient MC′_{i,j} of this matrix representing a multiplication factor applied to a common excitation time signal e(t) for its emission by the i-th emission transducer at the time of the j-th emission,
a calculation of acoustic field is carried out for each of the M′ successive initial emissions,
a reduced encoding matrix [MC], having a size of L×M, is obtained from the initial encoding matrix [MC′] by removal of M′−M column(s) corresponding to M′−M initial emission(s) eliminated on the basis of a selection criterion applied to the M′ calculations of acoustic fields, and
the control of the L emission transducers for the M successive emissions of ultrasound waves towards the zone of interest is encoded using the reduced encoding matrix [MC] applied to the common excitation time signal e(t).

Thus, starting from an encoding matrix [MC′] that can be one of those indicated above or another, in particular an encoding matrix ensuring a satisfactory SNR according to the intended use and the later processing planned, the invention allows to reduce the number of emissions by eliminating one or more emissions on the basis of a criterion that is relevant since it is related to calculations of acoustic fields. This manner of operating allows in particular to reduce the number of the emissions by limiting as much as possible the effect of this reduction on the SNR of the matrix [MR(t)].

Optionally, the matrix [MR(t)] of ultrasound time signals is decoded in order to obtain a decoded matrix [MR′(t)] calculated via matrix product in the following manner:

[MR′(t)]=[MR(t)]·[MC]^{T}·([MC]·[MC]^{T})⁻¹,

where “T” is the symbol of matrix transposition.

A matrix having a size of N×L, on the basis of which the same processing as with a matrix of time signals obtained by conventional acquisition of the FMC type is possible, is thus obtained.

Also optionally, the calculation of acoustic field carried out for each of the M′ successive initial emissions comprises the calculation of a simplified field model E_{m′}(f,θ) defined for each column having the index m′ of the initial encoding matrix [MC′] in the following manner:

$${E}_{{m}^{′}} ( f , θ ) = {\sum }_{l = 1}^{L} {MC}_{l , {m}^{′}}^{′} \cdot {s}_{l} ( f ) \cdot {D}_{l} ( f , θ ) {e}^{- j k ld sin θ} ,$$

where:
f is a temporal frequency,
θ is an angle with respect to a normal to a main plane or axis of the L emission transducers when the latter are aligned,
sₗ(f) is a transfer function of an l-th emission transducer,
Dₗ(f,θ) is a directivity function of the l-th emission transducer in a medium of emission of the ultrasound waves,
e is the exponential function,
j is the complex number such that j²=−1,
k is a wave number defined by k=2πf/c where c is the velocity of the ultrasound waves in the emission medium in question, and
d is an inter-element step, that is to say a common width of the emission transducers added to a distance between two neighbouring transducers.

Also optionally, the calculation of acoustic field carried out for each of the M′ successive initial emissions further comprises the calculation of an integrated field value A_{m′}(θ) on the basis of each simplified field model E_{m′}(f,θ) in the following manner:

$${A}_{{m}^{′}} ( θ ) = \vert {\int }_{{f}_{min}}^{{f}_{max}} {E}_{{m}^{′}} ( f , θ ) d f \vert = \vert {\sum }_{l = 1}^{L} {MC}_{l , {m}^{′}}^{′} \cdot {\int }_{{f}_{min}}^{{f}_{max}} {s}_{l} ( f ) \cdot {D}_{l} ( f , θ ) {e}^{- j k ld sin θ} \vert ,$$

where fₘᵢₙ and fₘₐₓ are respectively a minimum and maximum frequency of a bandwidth of the common excitation time signal e(t).

Also optionally, the selection criterion applied to the M′ calculations of acoustic fields comprises an amplitude threshold below which the contributions of the acoustic field are considered to be negligible.

Also optionally, each column of the initial encoding matrix [MC′] producing an initial emission, the calculation of acoustic field of which does not provide a value greater than or equal to the amplitude threshold, is eliminated.

Also optionally, the selection criterion applied to the M′ calculations of acoustic fields further comprises angular thresholding involving removing any contribution of the acoustic field outside of a predetermined angular sector.

Also optionally, the initial encoding matrix [MC′] is a Hadamard matrix or obtained from a Hadamard matrix.

A computer program that can be downloaded from a communication network and/or is recorded on a medium readable by computer and/or can be executed by a processor, comprising instructions for the execution of the steps of a method for acquiring signals according to the invention, when said program is executed on a computer, is also proposed.

An ultrasound probing device is also proposed, comprising:
a probe comprising a plurality of ultrasound emission transducers and a plurality of ultrasound reception transducers, and
means for controlling the transducers and for processing designed to implement a method for acquiring signals according to the invention.

The invention will be better understood via the following description, given only as an example and made in reference to the appended drawings in which:

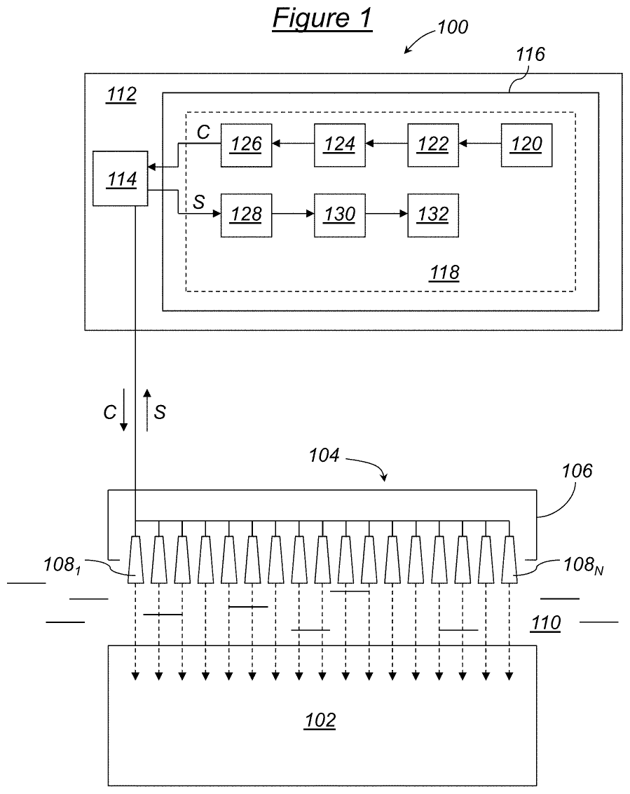

FIG. 1 schematically shows the overall structure of an ultrasound probing device according to an embodiment of the invention,

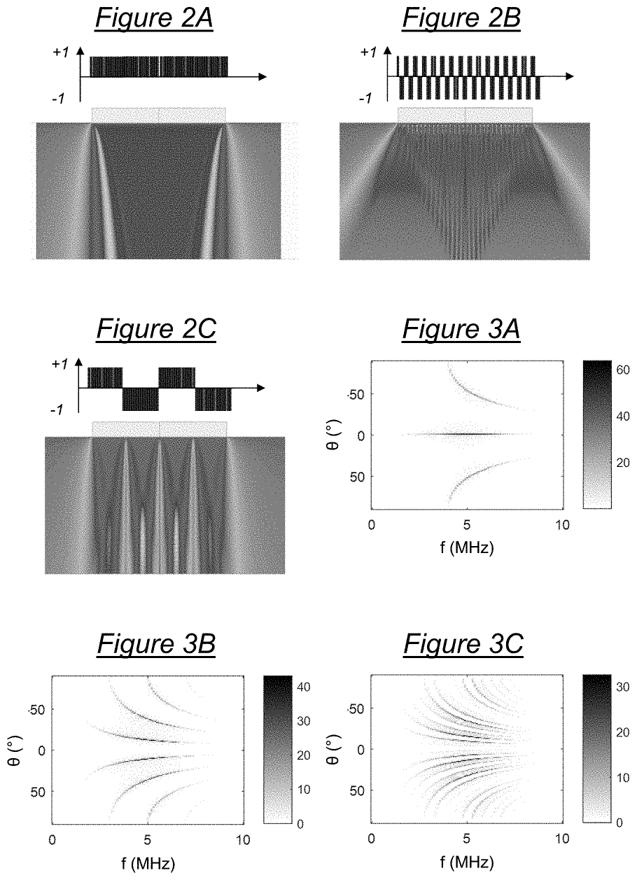

FIGS. 2A, 2B and 2C illustrate three examples of acoustic fields respectively corresponding to three encoded emissions carried out by a probing device such as that of FIG. 1,

FIGS. 3A, 3B and 3C illustrate three examples of calculations of acoustic fields respectively corresponding to three encoded emissions carried out by a probing device such as that of FIG. 1,

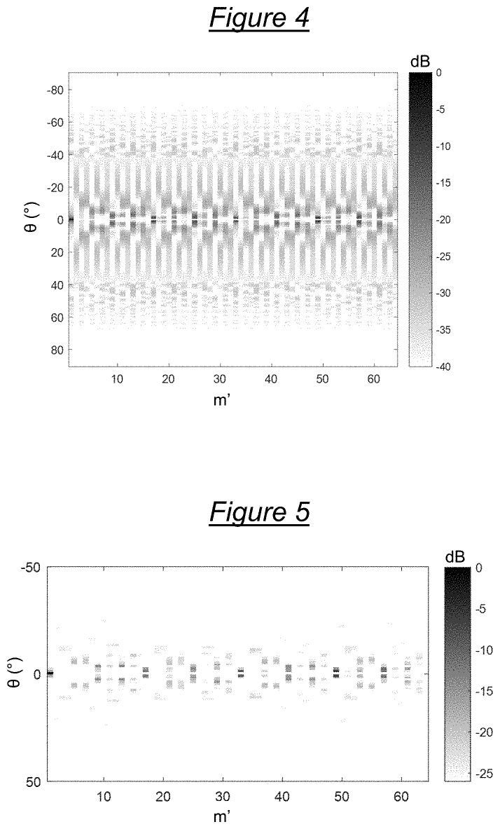

FIG. 4 illustrates another example of calculation of acoustic field using in particular the calculations of FIGS. 3A, 3B and 3C,

FIG. 5 illustrates the effect of thresholding carried out on the result of the calculation of FIG. 4,

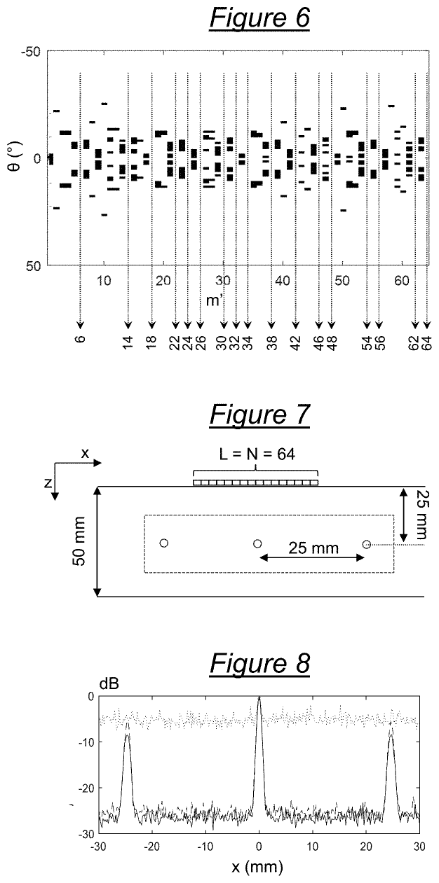

FIG. 6 illustrates the effect of a binarization carried out on the result of FIG. 5 with a view to removing encoded emissions,

FIG. 7 schematically shows an experimental facility for comparative tests,

FIG. 8 is a diagram illustrating results of comparative tests obtained with or without a probing device according to the invention on the experimental facility of FIG. 7,

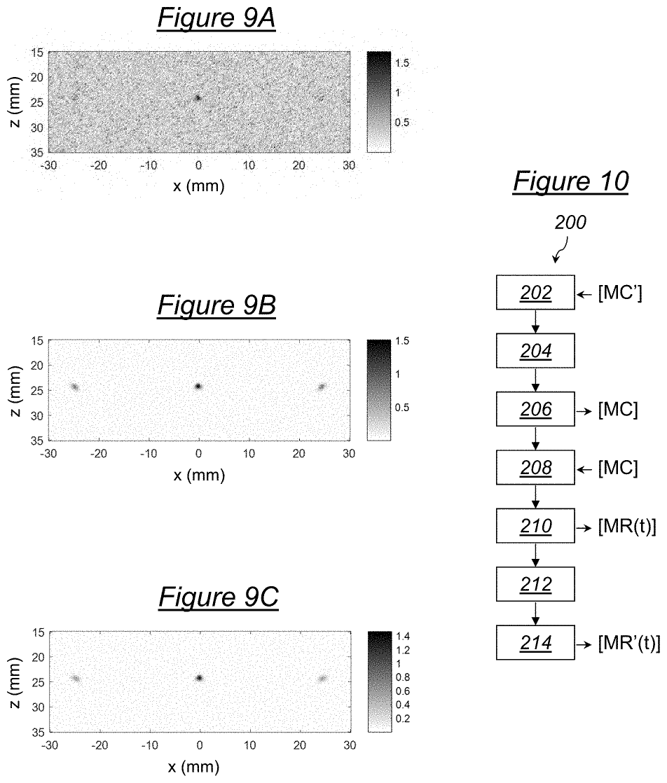

FIGS. 9A, 9B and 9C illustrate three images obtained by synthetic total focusing on time signals obtained by acquisition with or without a probing device according to the invention on the experimental facility of FIG. 7, and

FIG. 10 illustrates the steps of a method for acquiring ultrasound signals implemented by the device of FIG. 1.

In reference to FIG. 1, a device 100 for probing an object 102 according to an embodiment of the invention comprises an ultrasound probe 104 having a case 106, that is to say a non-deformable structural element that is used as a reference frame attached to the probe 104, in which are disposed, for example linearly or in a matrix, N fixed or mobile transducers 108₁, . . . , 108_{N}.

The object 102 is for example a mechanical part that it is desired to examine via non-destructive testing or, in a medical context, a human body part that it is desired to inspect non-invasively. In the embodiment of FIG. 1, the object 102 is submerged in a liquid, such as water 110, and the probe 104 is maintained at a distance from the object 102 in order to the water 110 to separate them. But in another equivalent embodiment, the probe 104 could be in direct contact with the object 102.

The transducers 108₁, . . . ,108_{N} are designed to emit ultrasound waves in the direction of the object 102 in response to control signals identified by the general reference C, in main directions parallel to each other, indicated by dotted arrows in FIG. 1, and in a main plane that is that of the drawing.

The transducers 108₁, . . . , 108_{N} are further designed to detect echoes of the ultrasound waves reflecting on and in the object 102 and to provide measurement signals identified by the general reference S and corresponding to these echoes. Thus, in the non-limiting example of FIG. 1, the N transducers 108₁, . . . , 108_{N} carry out the functions of both emission and reception, but receivers different than the emitters could also be provided in different and independent cases while remaining in conformity with the principles of the invention. Moreover, the number L of emitters could indeed be different than the number N of receivers.

The probing device 100 further comprises an electronic circuit 112 for control of the transducers 108₁, . . . , 108_{N} of the probe 104 and for processing of the measurement signals S. This electronic circuit 112 is connected to the probe 104 in order to transmit to it the control signals C and in order to receive the measurement signals S. The electronic circuit 112 is for example that of a computer. It has a central processing unit 114, such as a microprocessor designed to emit, to the probe 104, the control signals C and to receive, from the probe 104, the measurement signals S, and a memory 116 in which a computer program 118 is recorded.

The computer program 118 comprises first of all instructions 120 for defining M′ successive initial emissions using an initial encoding matrix [MC′] having a size of L×M', that is to say having a size of N×M' in the non-limiting example in question. Each coefficient MC′_{i,j} of this matrix represents a multiplication factor applied to an excitation time signal e(t), common to all the transducers 108₁, . . . , 108_{N}, for its emission by the i-th emission transducer at the time of the j-th emission. This multiplication factor can include a delay of a delay law applied to the j-th initial emission in question. The initial encoding matrix [MC′] can be predetermined and recorded in memory, chosen using the instructions 120 out of a set of initial encoding matrices recorded in memory, defined via a man-machine interface using the instructions 120, etc.

As indicated above, the initial encoding matrix [MC′] can be the identity matrix for M′=L=N successive initial emissions compliant with FMC acquisition.

It can also be a matrix, the non-zero coefficients of which including delay laws are located around its main diagonal, for M′<L=N successive initial emissions compliant with an acquisition as taught in the aforementioned article by Karaman et al.

It can also be a square Hadamard matrix H_{N}, for M′=L=N successive initial emissions compliant with an acquisition as taught in chapter II.A of the aforementioned article by Lopez Villaverde et al. In this case, the number N must be a power of 2.

It can also be a matrix obtained from a Hadamard matrix, for M′ successive initial emissions compliant with an acquisition as taught in chapter III-B of the aforementioned article by Lopez Villaverde et al. For example, this can be a horizontal concatenation of two matrices H_{N}⁺ and H_{N}⁻ resulting from the matrix H_{N} (H_{N}⁺=½(J_{N}+H_{N}) and H_{N}⁻=½(J_{N}−H_{N}), where J_{N} is the matrix having a size of N×N, all the coefficients of which are at 1), for M′=2L−1=2N−1 successive initial emissions. This can also simply be the matrix H_{N}⁺, for M′=L=N successive initial emissions.

Other initial encoding matrices [MC′] are possible for a person skilled in the art according to the concrete intended uses.

The computer program 118 further comprises instructions 122 for executing a calculation of acoustic field for each of the M′ successive initial emissions defined in the initial encoding matrix [MC′]. This acoustic field is dependent on the transducers themselves, in particular on the materials in which they are designed and on their size, on their positioning and on the medium in which the acoustic waves are emitted.

FIGS. 2A, 2B and 2C illustrate, in Cartesian coordinates and in spectra of amplitude, examples of acoustic fields obtained in response to predetermined encoded emissions. In these three examples, the transducers 108₁, . . . , 108_{N} are aligned, they are emitters and receivers, N=64 and the initial encoding matrix [MC′] is the Hadamard matrix H₆₄. More precisely, FIG. 2A illustrates the acoustic field obtained in Cartesian coordinates using a first initial emission encoded by the first column of the matrix H₆₄, consisting only of coefficients of 1. The acoustic field obtained is therefore that of a plane wave progressing in the direction normal to the transducers. FIG. 2B illustrates the acoustic field obtained using a third initial emission encoded by the third column of the matrix H₆₄. FIG. 2C illustrates the acoustic field obtained using a seventeenth initial emission encoded by the seventeenth column of the matrix H₆₄.

It is within the reach of a person skilled in the art to carry out a calculation of acoustic field given their general knowledge in the field, but a particularly ingenious calculation, aiming to reduce the calculation times, is provided below. It involves proposing a simplified field model E_{m′}(f,θ) defined for each column having the index m′ of the initial encoding matrix [MC′] in the following manner:

$${E}_{{m}^{′}} ( f , θ ) = {\sum }_{l = 1}^{L} {MC}_{l , {m}^{′}}^{′} \cdot {s}_{l} ( f ) \cdot {D}_{l} ( f , θ ) {e}^{- j k ld sin θ} ,$$

where:
f is a temporal frequency, for example expressed in MHz,
θ is an angle with respect to a normal to a main plane or axis of the transducers when the latter are aligned, −L=N in the example illustrated,
sₗ(f) is a transfer function of the transducer 108ₗ, for example taking the shape of a Gaussian signal around a central frequency,
Dₗ(f,θ) is a directivity function of the transducer 108ₗ in the medium of emission of the ultrasound waves, for example as taught as equation (7) in the article by Fan et al, entitled “A comparison between ultrasonic array beamforming and super resolution imaging algorithms for non-destructive evaluation”, published in Ultrasonics, volume 54, No. 7, pages 1842-1850, September 2014,
e is the exponential function,
j is the complex number such that j²=−1,
k is a wave number defined by k=2πf/c where c is the velocity of the ultrasound waves in the emission medium in question, and
d is the inter-element step, that is to say the common width of the transducers added to the distance between two neighbouring transducers.

FIGS. 3A, 3B and 3C illustrate examples of simplified calculations of acoustic fields obtained in response to predetermined encoded emissions. In these three examples, the transducers 108₁, . . . , 108_{N} are aligned, they are emitters and receivers, N=64 and the initial encoding matrix [MC′] is the Hadamard matrix H₆₄. Moreover, the inter-element step d is equal to 0.6 mm, the velocity c is equal to 2.3 mm/μs, the function sₗ(f) is chosen as taking the form of a Gaussian signal having a central frequency at 5 MHz with a bandwidth of 60% at −6 dB and the function Dₗ(f, θ) is defined according to the teaching of the aforementioned article by Fan et al for a common width of the transducers of 0.5 mm. More precisely, FIG. 3A illustrates a result of the calculation of acoustic field obtained for the first column of the matrix H₆₄: the frequency f, varying from 0 to 10 MHz, is shown on the axis of the abscissa of a two-dimensional reference frame; the angle θ, varying from −90 to +90 degrees, is shown on the axis of the ordinates of this two-dimensional reference frame; each point of the two-dimensional reference frame located inside the possible variations of f and θ is shown in greyscale and in arbitrary units according to the absolute value of the amplitude of the acoustic field calculated at this point. Likewise, FIG. 3B illustrates a result of the calculation of acoustic field obtained for the fourth column of the matrix H₆₄. Likewise, FIG. 3C illustrates a result of the calculation of acoustic field obtained for the sixteenth column of the matrix H₆₄.

Optionally but advantageously, the instructions 122 continue the calculation of the M′ preceding acoustic fields by integrating the results over the frequency bandwidth of the excitation time signal e(t). The minimum and maximum frequency of this bandwidth are labelled fₘᵢₙ and f_{max,} respectively. This thus gives an integrated field value A_{m′}(θ) that now depends only on θ, defined for each column having the index m′ of the initial encoding matrix [MC′] in the following manner:

$${A}_{{m}^{′}} ( θ ) = \vert {\int }_{{f}_{min}}^{{f}_{max}} {E}_{{m}^{′}} ( f , θ ) d f \vert = \vert {\sum }_{l = 1}^{L} {MC}_{l , {m}^{′}}^{′} \cdot {\int }_{{f}_{min}}^{{f}_{max}} {s}_{l} ( f ) \cdot {D}_{l} ( f , θ ) {e}^{- j k ld sin θ} \vert .$$

The diagram of FIG. 4 thus illustrates the variations in this integrated acoustic-field value as a function of the successive initial emissions, varying from the first to the M′-th (with M′=N=64 in the example illustrated) on the axis of the abscissa of a two-dimensional reference frame, and as a function of the possible values of the angle θ, varying from −90 to +90 degrees on the axis of the ordinates of this two-dimensional reference frame. More precisely, the diagram of FIG. 4 illustrates this integrated value in logarithmic values by calculating the grey level of each point of the two-dimensional reference frame located inside the possible variations of m′ and θ on the basis of the following value:

$${A LOG}_{{m}^{′}} ( θ ) = 20 \cdot log ( \frac{{A}_{{m}^{′}} ( θ )}{{A}_{1} ( 0 )} ) .$$

Indeed, it is noted that A₁(0) is the maximum value that A_{m′}(θ) can have as a function of m′ and θ.

The computer program 118 further comprises instructions 124 for removing M′−M column(s) of the initial encoding matrix [MC′] (M<M′), this/these removed column(s) corresponding to M′−M initial emission(s) removed on the basis of a selection criterion applied to the M′ calculations of acoustic fields executed by the instructions 122. These instructions allow to obtain a reduced encoding matrix [MC] having a size of L×M, only comprising the non-removed columns of the initial encoding matrix [MC′] and defining the M emissions thus selected.

FIGS. 5 and 6 illustrate the application of a non-limiting example of a selection criterion. FIG. 5 illustrates in particular the application of an amplitude threshold TH to the logarithmic values ALOG_{m′}(θ) of FIG. 4 below which the contributions of the acoustic field are considered to be negligible. This threshold TH is for example set to 5% of the maximum amplitude reached by A_{m′}(θ) over the entirety of the emissions and for all the angles θ, or −26 dB on the logarithmic scale. This amplitude threshold TH could optionally be completed by angular thresholding involving removing any contribution of the acoustic field outside of a predetermined angular sector. It is observed nevertheless that in the example of FIGS. 4 and 5, such angular thresholding is implicit since no logarithmic value ALOG_{m′}(θ) exceeds −26 dB beyond the angular sector [−30°; +30°]. FIG. 6 repeats FIG. 5 after binarization of its values. All the values A_{m′}(θ) that are non-zero after thresholding are illustrated in black, the others in white. It is thus observed in FIG. 6 that certain initial emissions can be considered overall to be a negligible contribution since the corresponding values A_{m′}(θ) for all the angles θ are less than the threshold TH, that is to say zero after binarization. In this example, these are the emissions having the indices m′=6, 14, 18, 22, 24, 26, 30, 32, 34, 38, 42, 46, 48, 54, 56, 62 and 64. The selection criterion thus involves removing the corresponding columns in the initial encoding matrix [MC′] in order to obtain the reduced encoding matrix [MC]. In the example illustrated, the seventeen columns having the indices m′=6, 14, 18, 22, 24, 26, 30, 32, 34, 38, 42, 46, 48, 54, 56, 62 and 64 of the initial encoding matrix [MC′]=H₆₄ are thus removed in order to obtain a reduced encoding matrix [MC] with M=47 columns. The number of successive emissions is thus reduced by a little more than 26% without substantial degradation of the SNR upon reception.

The computer program 118 further comprises instructions 126 for generating the signals C for control of the transducers 108₁, . . . , 108_{N} in such a way as to:
activate the L=N transducers 108₁, . . . , 108_{N} as emitters in order to execute the M selected successive emissions of ultrasound waves towards a zone of interest of the object 102,
activate the N transducers 108₁, . . . , 108_{N} as receivers in order to, after each of the M successive emissions, simultaneously receive, by these N receivers and for a predetermined time from the desired depth of

inspection, N measurement signals measuring in particular echoes caused

by reflections of the emission in question in the zone of interest.

The set S of the N×M measurement signals thus transmitted by the transducers 108₁, . . . , 108_{N} is sent back by the probe 104 to the central processing unit 114.

The computer program 118 thus further comprises instructions 128 for constructing a matrix [MR(t)] of ultrasound time signals having a size of N×M, each coefficient MR_{i,j}(t) of this matrix representing the measurement signal received by the transducer 108ᵢ in response to the j-th emission.

Optionally, the computer program 118 further comprises instructions 130 for carrying out temporal filtering of the matrix [MR(t)], this filtering aiming to remove any information located at times of flight excluded from the zone of interest in the object 102.

Finally, the computer program 118 comprises instructions, designated by the general reference 132, for processing the matrix [MR(t)]. The processing carried out by the instructions 132 can include:
optional decoding according to the reduced encoding matrix [MC] obtained using the instructions 124,
noise-reduction processing for example such as that taught in the patent application WO 2014/009671 A1,
adaptive and selective focusing such as filtering of the DORT type (from the French “Décomposition de l′opérateur de Retournement Temporel”, or Decomposition of the Time Reversal Operator),
a reconstruction of a digital image of the zone of interest in the object 102 by synthetic focusing of the “total focusing method” type, or by other specific processing known per se for obtaining an image of the type B-Scan, S-Scan or other.

It can in particular be demonstrated that the matrix [MR′(t)], obtained by the following decoding:

[MR′(t)]=[MR(t)]·[MC]^{T}·([MC]·[MC]^{T})⁻¹,

is a matrix that can be used in the same manner as the matrix of time signals obtained by conventional acquisition of the FMC type. It is noted that in general it has a size of N×L, that is to say square having a size of N×N when the transducers are emitters and receivers. It is, however, clearly less noisy than that obtained by conventional acquisition.

As an experiment, a simulation was carried out for the example of the previous figures, i.e.: the transducers 108₁, . . . , 108_{N} are aligned; L=N=64; the initial encoding matrix [MC′] is the Hadamard matrix H₆₄; the inter-element step d is equal to 0.6 mm; the propagation medium is such that the velocity c is equal to 2.3 mm/μs; the function sₗ(f) is chosen as taking the form of a Gaussian signal having a central frequency at 5 MHz with a bandwidth of 60% at −6 dB; the function Dₗ(f, θ) is defined according to the teaching of the aforementioned article by Fan et al for a common width of the transducers of 0.5 mm. Moreover, as shown by FIG. 7, the medium inspected comprises three artificial defects of the type Calibration Hole (CH) at a depth of 25 mm and they are distant from each other by 25 mm.

By carrying out the selection as defined above and by thus removing seventeen columns from the sixty-four in the Hadamard matrix H₆₄, the comparative results of FIG. 8 are obtained. The first curve shown as a solid line illustrates at the depth of 25 mm the amplitude in decibels of the signals obtained, after decoding, by application of the reduced encoding matrix [MC] to forty-seven columns. The second curve shown as a dashed line, barely visible behind the curve shown as a solid line, illustrates at the depth of 25 mm the amplitude in decibels of the signals obtained without reduction of the initial encoding matrix H₆₄. This quasi-superposition of the two curves shows that the removal of the seventeen columns that do not significantly contribute to the acoustic field emitted also does not have a significant effect on the results. Finally, the third curve shown as a dotted line illustrates at the depth of 25 mm the amplitude in decibels of the signals obtained by FMC acquisition. This third curve illustrates all the advantages of the (initial) encoding via Hadamard matrix.

If digital images are reconstructed by synthetic focusing of the “total focusing method” type on each of the preceding results, the images of FIGS. 9A, 9B and 9C are obtained. More precisely, FIG. 9A illustrates the image obtained by total focusing on a conventional FMC acquisition. FIG. 9B illustrates the image obtained by total focusing on an acquisition encoded by the Hadamard matrix H₆₄. FIG. 9C illustrates the image obtained by total focusing on an acquisition encoded by the reduced encoding matrix obtained by removal of the seventeen aforementioned columns of the Hadamard matrix H₆₄. The images of FIGS. 9B and 9C are clearly less noisy that the image of FIG. 9A. Moreover, the images of FIGS. 9B and 9C are of very comparable quality whereas that of FIG. 9C was obtained by an acquisition that is clearly much faster (gain of 26% in terms of number of successive emissions).

In reference to FIG. 10, a method 200 for acquisition and processing of ultrasound signals implemented by the device 100 of FIG. 1 will now be described.

During a step 202, the processing unit 114 executing the instructions 120 defines M′ successive initial emissions using an initial encoding matrix [MC′] having a size of L×M', that is to say a size of N×M' in the non-limiting example in question.

During a step 204, the processing unit 114 executing the instructions 122 carries out a calculation of acoustic field for each of the M′ successive initial emissions defined in the initial encoding matrix [MC′], for example according to the example illustrated by FIGS. 3A, 3B, 3C and 4.

During a step 206, the processing unit 114 executing the instructions 124 removes M′−M column(s) from the initial encoding matrix [MC′] (M<M′), this or these removed columns corresponding to M′−M initial emissions removed on the basis of a selection criterion applied to the M′ calculations of acoustic fields executed by the instructions 122, in order to obtain a reduced encoding matrix [MC] having a size of L×M, that is to say having a size of N×M in the non-limiting example in question. The selection criterion applied is for example that illustrated by FIGS. 5 and 6.

During a step 208, the processing unit 114 executing the instructions 126 controls the sequences of emissions and of receptions of the transducers 108₁, . . . , 108_{N} using the reduced encoding matrix [MC] for the acquisition of the matrix [MR(t)]. After each firing, the signals are received on all of the N transducers, digitized and transmitted to the electronic circuit 112.

During a step 210, the processing unit 114 executing the instructions 128 constructs the matrix [MR(t)], each coefficient MR_{i,j}(t) of this matrix representing the measurement signal received by the transducer 108ᵢ in response to the j-th emission, this signal being digitized in order to facilitate its later processing.

During an optional step 212, the processing unit 114 executing the instructions 130 carries out temporal filtering of the matrix [MR(t)], this filtering aiming to remove any information located at times of flight excluded from the zone of interest. The goal of this step 206 is to facilitate the later processing, in particular when the defects to be imaged are close to a strongly echogenic interface, like a bottom of a part. It allows to limit the zone to be imaged to the close vicinity of the defects by excluding in particular the disturbing echogenic interfaces. It is very advantageous in the imaging of cracks forming from the bottom of the object.

Finally, during a last step 214, the processing unit 114 executing the instructions 132 carries out one or more of the processing cited above: optional decoding according to the reduced encoding matrix [MC] used to obtain the matrix [MR′(t)] defined above, noise reduction, adaptive and selective focusing, reconstruction of a digital image of the zone of interest in the object 102, etc.

It is clear that a probing device such as that described above, implementing the acquisition method described in detail above, allows to simplify the acquisition of the ultrasound signals by reducing the number of the emissions, while limiting as much as possible the effect of this reduction on the SNR of the matrix of time signals obtained.

Moreover, it is noted that the invention is not limited to the embodiment described above. Indeed, it is clear to a person skilled in the art that various modifications can be made to the embodiment described above, in light of the teaching that has just been disclosed to them.

In particular, at least a portion of the computer program instructions 120, 122, 124, 126, 128, 130 and 132 could be replaced by microprogrammed or micro-wired electronic circuits, dedicated to the functions carried out during the execution of these instructions.

Moreover, the results and calculations of FIGS. 3A to 9C were obtained and carried out using emission encoding via Hadamard matrix, but similar results and calculations can be obtained and carried out using emission encoding such one of those described in chapter III.b of the aforementioned article by Lopez Villaverde et al or another. The nature of the initial encoding matrix does not in any way change the principles of the present invention.

Also moreover, in the embodiment described in detail above, L=N=M′. But there is no particular reason for these three parameters to be equal in general.

In general, in the following claims, the terms used must not be interpreted as limiting the claims to the embodiment disclosed in the present description, but must be interpreted to include all the equivalents that the claims aim to cover by their formulation and the providing of which is within the reach of a person skilled in the art by applying their general knowledge to the implementation of the teaching that has just been disclosed thereto.

1. A method for acquiring signals via ultrasound probing, comprising the following steps:
controlling L emission transducers for M successive emissions of ultrasound waves towards a zone of interest,
controlling N reception transducers in such a way as to receive simultaneously and over a predetermined time, for each of the M successive emissions, N measurement signals, measuring in particular echoes caused by reflections of the emission in question in the zone of interest,
obtaining a matrix [MR(t)] of ultrasound time signals having a size of N×M, each coefficient MR_{i,j} of this matrix representing the measurement signal received by the i-th reception transducer caused by the j-th emission, wherein:
an initial matrix [MC′], having a size of L×M′, for encoding the successive emissions is previously defined for a number M′ of successive initial emissions strictly greater than M, each coefficient MC′_{i,j} of this matrix representing a multiplication factor applied to a common excitation time signal e(t) for its emission by the i-th emission transducer at the time of the j-th emission,
a calculation of acoustic field is carried out for each of the M′ successive initial emissions,
a reduced encoding matrix [MC], having a size of L×M, is obtained from the initial encoding matrix [MC′] by removal of M′−M column(s) corresponding to M′−initial emissions eliminated on the basis of a selection criterion applied to the M′ calculations of acoustic fields, and
the control of the L emission transducers for the M successive emissions of ultrasound waves towards the zone of interest is encoded using the reduced encoding matrix [MC] applied to the common excitation time signal e(t).

2. The method for acquiring signals according to claim 1, wherein the matrix [MR(t)] of ultrasound time signals is decoded in order to obtain a decoded matrix [MR′(t)] calculated via matrix product in the following manner:
[MR′(t)]·=[MR(t)]·[MC]^{T}·([MC]·[MC]^{T})⁻¹,
where “T” is the symbol of matrix transposition.

3. The method for acquiring signals according to claim 1, wherein the calculation of acoustic field carried out for each of the M′ successive initial emissions comprises the calculation of a simplified field model E_{m′}(f, 0) defined for each column having the index m′ of the initial encoding matrix [MC′] in the following manner:
$${E}_{{m}^{′}} ( f , θ ) = {\sum }_{l = 1}^{L} {MC}_{l , {m}^{′}}^{′} \cdot {s}_{l} ( f ) \cdot {D}_{l} ( f , θ ) {e}^{- j k ld sin θ} ,$$
where:
f is a temporal frequency,
θ is an angle with respect to a normal to a main plane or axis of the L emission transducers when the latter are aligned,
s₁(f) is a transfer function of an 1-th emission transducer,
D₁(f, θ) is a directivity function of the 1-th emission transducer in a medium of emission of the ultrasound waves,
e is the exponential function,
j is the complex number such that j²=−1,
k is a wave number defined by k=2πf/c where c is the velocity of the ultrasound waves in the emission medium in question, and
d is an inter-element step, that is to say a common width of the emission transducers added to a distance between two neighbouring transducers.

4. The method for acquiring signals according to claim 3, wherein the calculation of acoustic field carried out for each of the M′ successive initial emissions further comprises the calculation of an integrated field value A_{m′}(θ) on the basis of each simplified field model E_{m′}(f, θ) in the following manner:
$${A}_{{m}^{′}} ( θ ) = \vert {\int }_{{f}_{min}}^{{f}_{max}} {E}_{{m}^{′}} ( f , θ ) d f \vert = \vert {\sum }_{l = 1}^{L} {MC}_{l , {m}^{′}}^{′} \cdot {\int }_{{f}_{min}}^{{f}_{max}} {s}_{l} ( f ) \cdot {D}_{l} ( f , θ ) {e}^{- j k ld sin θ} \vert ,$$
where fₘᵢₙ and fₘₐₓ are respectively a minimum and maximum frequency of a bandwidth of the common excitation time signal e(t).

5. The method for acquiring signals according to claim 1, wherein the selection criterion applied to the M′ calculations of acoustic fields comprises an amplitude threshold below which the contributions of the acoustic field are considered to be negligible.

6. The method for acquiring signals according to claim 5, wherein each column of the initial encoding matrix [MC′] producing an initial emission, the calculation of acoustic field of which does not provide a value greater than or equal to the amplitude threshold, is eliminated.

7. The method for acquiring signals according to claim 1, wherein the selection criterion applied to the M′ calculations of acoustic fields further comprises angular thresholding involving removing any contribution of the acoustic field outside of a predetermined angular sector.

8. The method for acquiring signals according to claim 1, wherein the initial encoding matrix [MC′] is a Hadamard matrix or obtained from a Hadamard matrix.

9. A computer program that can be downloaded from a communication network and/or is recorded on a medium readable by computer and/or can be executed by a processor, comprising instructions for executing the steps of a method for acquiring signals according to claim 1, when said program is executed on a computer.

10. An ultrasound probing device, comprising:
a probe comprising a plurality of ultrasound emission transducers and a plurality of ultrasound reception transducers, and
means for controlling the transducers and for processing designed to implement a method for acquiring signals according to claim 1.
